(19) United States
(12) Patent Application Publication
(10) Pub. No.: US 2025/0312716 A1
(43) Pub. Date: Oct. 9, 2025

(54) FILTER MEDIA AND METHODS OF MAKING THEM

(71) Applicant: NEENAH GESSNER GMBH, Bruckmühl (DE)

(72) Inventors: Anja KAMPE, Bruckmühl (DE); Adreas DEMMEL, Bruckmühl (DE); Werner HÖRL, Bruckmühl (DE)

(21) Appl. No.: 19/244,314

(22) Filed: Jun. 20, 2025

Related U.S. Application Data
(63) Continuation of application No. PCT/EP2023/087264, filed on Dec. 21, 2023.

(30) Foreign Application Priority Data
Dec. 22, 2022 (DE) 10 2022 134 516.5

(51) Int. Cl. B01D 39/16; B01D 39/18

(52) U.S. Cl. CPC B01D 39/1623; B01D 39/18; B01D 2239/065; B01D 2239/1216; B01D 2239/1233

(57) ABSTRACT

Filter media, filters and methods for making the same are provided herein. A filter media comprises a fibrous layer having a first portion and a second portion, the first portion and second portions being disposed next to each other along a thickness direction of the layer. The fibers from the first portion are intermeshed with the fibers from the second portion. A weight ratio of the fibers in the first portion to the fibers in the second portion is greater than 1:1. In certain embodiments, the fibrous layer comprise synthetic fibers, and two different types of cellulosic fiber. The synthetic fibers constitute less than 20 wt % of the fibers in the fibrous layer, and the second portion comprises more synthetic fibers, in terms of mass per unit area, than the first portion.

### CROSS-REFERENCE TO RELATED APPLICATIONS

This is a U.S. national phase entry of International Application No. PCT/EP2023/087264, filed Dec. 21, 2023, which claims the benefit of DE Application No. 10 2022 134516.5, filed Dec. 22, 2022, the complete disclosures of which are incorporated herein by reference for all purposes.

### FIELD

This description generally relates to filter media, filters and methods of making the same, and their use in filtration, particular for situations where there is a low air flow.

### BACKGROUND

Filtration media have uses in many fields. They are typically used to remove undesirable components from a stream of fluid, which may be a gas or liquid. A filter medium has a number of different properties including thickness, basis weight, dust holding capacity, filter efficiency, permeability, pore size, and mechanical properties such as burst strength, tensile strength and elongation at break. It is often desirable to improve one property in a filter medium so that it is suited to a particular situation. However, by doing so, other properties can be adversely affected. For example, decreasing the pore size of a filter could be expected to decrease its permeability, given that you may expect this to decrease the total pore volume that allows fluid flow through the filter. One way of addressing this is to create different layers with different properties and then combining the layers into a filter medium. This can be effective, but it has the disadvantage of increasing the thickness of filters and there are multiple steps in the manufacturing process, as each layer needs to be created separately, which may require different equipment or the sequential use of the same equipment, and then the layers need to be adhered together. Alternatively, or in addition, additives can be introduced into a filter to alter its properties, but these additives are sometimes expensive.

In view of the above, it is a challenge to produce a filter medium that has particular properties for a certain situation. It is a challenge, for example, to produce a filter medium that could be used particularly in a low velocity air flow situation, that has a high air permeability, a high dust absorption, a high efficiency, and good mechanical properties, while being of a relatively low thickness and being cost-efficient to make, both in materials and manufacturing process. Ideally, the filter medium could also be adapted, e.g. by impregnation with a fire retardant and/or by corrugation, and still retain its advantageous properties. Some filters which have addressed at least one aspect of this challenge include those that include a nanofiber layer, e.g. as described in WO2016/040900 and US2022/0118387. However, the filters described in these documents take multiple steps to make and the nanofiber layers and other additives they use are expensive.

### SUMMARY

The following presents a simplified summary of the claimed subject matter in order to provide a basic understanding of some aspects of the claimed subject matter. This summary is not an extensive overview of the claimed subject matter. It is intended to neither identify key or critical elements of the claimed subject matter nor delineate the scope of the claimed subject matter. Its sole purpose is to present some concepts of the claimed subject matter in a simplified form as a prelude to the more detailed description that is presented later.

Filter media, filters and methods of making the same are provided herein.

In one aspect, a filter medium comprises a fibrous layer having a first portion and a second portion. The first portion and second portions are disposed next to each other along a thickness direction of the layer, and the fibers from the first portion being intermeshed with the fibers from the second portion, wherein the weight ratio of the fibers in the first portion to the fibers in the second portion is n:1, wherein n is >1.

Applicant has surprisingly discovered that the filter medium has a particularly desirable balance of properties, particularly in the context of low velocity air flow. As illustrated in the Examples, the filter medium has a higher dust absorption and higher air permeability compared to a comparative filter medium containing cellulosic fibers, but lacking synthetic fibers, while having high efficiency. Furthermore, the filter medium can be produced cost effectively using cellulosic fibers and a relatively low amount of synthetic fibers. The layer of the filter medium has two, typically lamellar, portions overlying one another, but they are created together, such that the fibers from one portion intermesh with the other where the two portions meet—as such, the portions are not discrete layers, as they would be had two layers been created separately and adhered together. The layer containing the two portions can be created in a single manufacturing process, e.g. by wet laying one portion on the other while the first portion is still wet, and then removing liquid from the two portions, creating the intermeshing of fibers between the two portions. This avoids having to adhere two layers together and the potential difficulty of having a sharp interface between two layers.

In embodiments, the fibrous layer comprises synthetic fibers and cellulosic fibers. The synthetic fibers comprise between about 1 wt % and 20 wt % of the fibers in the fibrous layer, or about 3 to 15 wt.-%, or about 5 to 10 wt.-%, or about 8 to 16 wt % of the fibers in the fibrous layer as a whole.

In embodiments, the second portion comprises more synthetic fibers, in terms of mass per unit area, than the first portion.

In embodiments, the synthetic fibers have a linear density of 2 dtex or less. In an exemplary embodiment, the synthetic fibers have a linear density of from 0.01 dtex to 1 dtex, or abou 0.04 to 0.6 dtex, or about 0.05-0.5 dtex, or about 0.1 to 0.3 dtex.

In embodiments, the synthetic fibers have a fiber diameter of from 0.1 μm to 20 μm or about 0.1 μm to 10 μm, or about 0.1 to 5 μm, or about 0.5 to 5 μm.

In embodiments, the synthetic fibers are selected from a group consisting of polymeric fibers, inorganic fibers and combinations thereof.

In embodiments, the polymeric fibers comprise a material selected from the group consisting of a polyester, a polycarbonate, a polyamides, polyaramid, polyimide, a polyolefin, a polyether ether ketone, an acrylic, a polyvinyl alcohol, a polyacrylonitrile, a polyvinylidene fluoride (PVDF), a silicone, a polyether sulfone and combinations thereof.

In embodiments, the inorganic fibers comprise a material selected from the group consisting of glass, carbon, ceramic, silica and combinations thereof.

In embodiments, the first portion comprises hardwood cellulose fibers and softwood cellulose fibers.

In embodiments, the second portion comprises synthetic fibers and cellulosic fibers in a weight:weight ratio of 80:20 to 20:80.

In embodiments, the weight ratio of the fibers in the first portion to the fibers in the second portion is about 2:1 to about 10:1.

In embodiments, the fibrous layer has a mean pore size of from 8 to 35 μm as determined according to DIN ISO 4003:1910-10 and an air permeability of at least 165 l/m²s as determined according to DIN EN ISO 9237 1995-12 at 200 Pa pressure difference.

In embodiments, the fibrous layer has a basis weight of from 80 to 140 g/m² determined according to DIN 546:2019-11.

In a second aspect, a method of making a filter medium comprises forming a fibrous layer on a substrate, wherein the fibrous layer has a first portion and a second portion, such that the first portion and second portion are disposed next to each other along a thickness direction of the layer, and the fibers from the first portion being intermeshed with the fibers from the second portion, wherein the weight ratio of the fibers in the first portion to the fibers in the second portion is n:1, wherein n is >1, wherein the fibrous layer comprises synthetic fibers, and two different types of cellulosic fiber, the synthetic fibers constitute less than 20 wt % of the fibers in the fibrous layer, and the second portion comprises more synthetic fibers, in terms of mass per unit area, than the first portion, removing the fibrous layer from the substrate. The method may produce a filter medium according to the first aspect.

In another aspect, a filter medium is producible according to the method of the second aspect.

In another aspect, further a filter element comprising the filter medium according to the first aspect or producible according to the second aspect.

In another aspect, use of the filtration medium of the first aspect or the filter element of the third aspect in filtering a fluid is provided. The filtering may act to remove particulates, e.g. dust, from the fluid. The fluid may be a gas or a liquid. The gas may be air. The liquid may be a fuel, e.g. a hydrocarbon fuel. The fluid may be a gas and the gas may be flowing at a velocity of 20 cm/s or less, optionally 15 cm/s or less, optionally 10 cm/s or less.

The recitation herein of desirable objects which are met by various embodiments of the present description is not meant to imply or suggest that any or all of these objects are present as essential features, either individually or collectively, in the most general embodiment of the present description or in any of its more specific embodiments.

### BRIEF DESCRIPTION OF THE DRAWING

FIG. 1 is a schematic of the layers of a filter medium with a layer comprising two portions.

### DETAILED DESCRIPTION

This description and the accompanying drawings illustrate exemplary embodiments and should not be taken as limiting, with the claims defining the scope of the present description, including equivalents. Various mechanical, compositional, structural, and operational changes may be made without departing from the scope of this description and the claims, including equivalents. In some instances, well-known structures and techniques have not been shown or described in detail so as not to obscure the description. Like numbers in two or more figures represent the same or similar elements. Furthermore, elements and their associated aspects that are described in detail with reference to one embodiment may, whenever practical, be included in other embodiments in which they are not specifically shown or described. For example, if an element is described in detail with reference to one embodiment and is not described with reference to a second embodiment, the element may nevertheless be claimed as included in the second embodiment. Moreover, the depictions herein are for illustrative purposes only and do not necessarily reflect the actual shape, size, or dimensions of the system or illustrated components.

It is noted that, as used in this specification and the appended claims, the singular forms “a,” “an,” and “the,” and any singular use of any word, include plural referents unless expressly and unequivocally limited to one referent. As used herein, the term “include” and its grammatical variants are intended to be non-limiting, such that recitation of items in a list is not to the exclusion of other like items that can be substituted or added to the listed items.

Except as otherwise noted, any quantitative values are approximate whether the word “about” or “approximately” or the like are stated or not. The materials, methods, and examples described herein are illustrative only and not intended to be limiting.

### Synthetic Fibers

The synthetic fibers preferably have a linear density of 5 dtex or less, optionally 2 dtex or less, optionally 1 dtex or less. The synthetic fibers preferably have a linear density of at least 0.01 dtex, optionally at least 0.05 dtex, optionally at least 0.01 dtex. The synthetic fibers preferably have a linear density of from 0.01 dtex to 5 dtex, optionally from 0.01 dtex to 3 dtex, optionally from 0.01 dtex to 3 dtex, optionally from 0.04 to 0.6 dtex, optionally from 0.05-0.5 dtex, optionally from 0.1 to 0.3 dtex. The linear density of fibers may be measured using known techniques, e.g. measured according to the standard methods described in ASTM D 1577 2018 or DIN 53812.

The synthetic fibers may have a fiber diameter of from 0.1 μm to 20 μm, optionally from 0.1 μm to 10 μm, optionally from 0.1 to 5 μm, optionally from 0.5 to 5 μm. The synthetic fibers may have an average fiber diameter of from 0.1 μm to 20 μm, optionally from 0.1 μm to 10 μm, optionally from 0.1 to 5 μm, optionally from 0.5 to 5 μm. The fiber diameter, which may be an average fiber diameter, may be measured according to techniques, e.g. calculation from knowing the linear density (e.g. in dtex) and the density of the material of the synthetic fiber (e.g. in g/cm³) or by a microscopic technique as described below in relation to cellulosic fibers.

Fibers with the linear density and/or diameters mentioned above have been found to be particularly effective in the filter medium.

The synthetic fibers may be selected from polymeric and inorganic fibers. The polymeric fibers may comprise a material selected from a polyester, a polycarbonate, a polyamides, polyaramid, polyimide, a polyolefin, polyether ether ketone, polyolefin, acrylics, polyvinyl alcohol, polyacrylonitriles, polyvinylidene fluoride (PVDF), silicone, and polyether sulfones. The polyesters may be selected from polyethylene terephthalate and polybutylene terephthalate. The polyamides may be a nylon. The polyolefin may be selected from polyethylene and polypropylene. The polymer may be a co-polymer of any of the specific polymers mentioned herein.

The inorganic fibers may comprise a material selected from glass, carbon, ceramic and silica.

The inorganic fibers may be bi-component fibers, e.g. having a core of one material and an outer sheath of another material, which may both be selected from the materials mentioned above.

The length of the synthetic fibers may be any suitable length to allow intermeshing with each other and with cellulosic fibers. The fibers may have a length, which may be an average length, of from 0.1 mm to 10 mm, optionally from 0.1 to 8 mm, optionally from 0.5 to 8 mm, optionally from 0.5 to 8 mm, optionally from 1 to 8 mm, optionally from 1 to 5 mm. The length may be measured by any known technique, e.g. a microscopic technique as described below for cellulosic fibers or in accordance with a standard technique, such as the KS K 0327-2008 test method for synthetic short fibers.

The synthetic fibers constitute less than 20 wt % of the fibers in the fibrous layer as a whole, and the second portion comprises more synthetic fibers, in terms of mass per unit area (of the fibrous layer), than the first portion. The synthetic fibers may constitute 3 to 15 wt.-%, more preferably from 5 to 10 wt.-%, more preferably 8 to 16 wt % of the fibers in the fibrous layer as a whole. Preferably, the second portion comprises synthetic fibers and cellulosic fibers in a weight:weight ratio of 80:20 to 20:80, optionally 30:70 to 70:30, optionally 60:40 to 40:60, optionally 58:42 to 42:58, optionally from 45:55 to 55:45, optionally about 50:50. Preferably, at least 80 wt % of the synthetic fibers in the fibrous layer are present in the second portion, optionally at least 70 wt %, optionally at least 80 wt %, optionally at least 90 wt %. Owing to the specific structure of the fibrous layer, the amount of synthetic fibers can be reduced to a relatively low amount, as compared with some prior art filter medium materials, and advantageous filtration properties or mechanical properties still obtained.

The presence of synthetic fibers, particularly of the linear density and/or diameter mentioned herein, together with the structure of the fibrous layer, leads to a filter medium having a higher air permeability, yet with a smaller average pore size and greater dust absorption properties, as compared to a fibrous layer lacking the dual portion structure and synthetic fibers.

### Cellulosic Fibers

The filter medium comprises two different types of cellulosic fiber. The first portion preferably comprises two different types of cellulosic fiber. The at least two different types of cellulosic fibers may differ with respect to at least one property selected from the fiber titer, fiber origin (hardwood/softwood), average fiber diameter, and average fiber length.

Average fiber diameter and average fiber length may be determined using known procedures in the art. The term “average fiber length” as used herein may refer to an average length of fibers, fiber bundles and/or fiber-like materials determined by measurement utilizing microscopic techniques as described as follows. A sample of at least 20 randomly selected fibers is separated from a liquid suspension of fibers. The fibers are set up on a microscope slide prepared to suspend the fibers in water. A tinting dye is added to the suspended fibers to color cellulose-containing fibers so they may be distinguished or separated from synthetic fibers. The slide is placed under a microscope, e.g. a Fisher Stercomaster II Microscope—S19642/S19643 Series. Measurements of 20 fibers in the sample are made at suitable magnification and scale (e.g. 20× linear magnification utilizing a 0-20 mils scale) and an average length, minimum and maximum length, and a deviation or coefficient of variation are calculated. In some cases, the average fiber length will be calculated as a weighted average length of fibers (e.g., fibers, fiber bundles, fiber-like materials) determined by equipment such as, for example, a Kajaani fiber analyzer Model No. FS-200, available from Kajaani Oy Electronics, Kajaani, Finland. According to a standard test procedure, a sample is treated with a macerating liquid to ensure that no fiber bundles or shives are present. Each sample is disintegrated into hot water and diluted to an approximately 0.001% suspension. Individual test samples are drawn in approximately 50 to 100 ml portions from the dilute suspension when tested using the standard Kajaani fiber analysis test procedure. The weighted average fiber length may be an arithmetic average, a length weighted average or a weight weighted average and may be expressed by the following equation:

$${\sum }_{{x}_{i} = 0}^{k} ( {x}_{i} * {n}_{i} ) / n$$

$$where$$

$$k = maximum fiber length$$

$${x}_{i} = fiber length$$

$${n}_{i} = number of fibers having length xi$$

$$n = total number of fibers measured .$$

The average fiber diameter can be determined in the same manner as above, except by measuring the fiber diameters for the samples instead of fiber length, and by substituting “fiber length” with “fiber diameter” in the passage above.

Preferably, the two different types of cellulosic fiber are hardwood fibers and softwood fibers. It has been found that softwood derived fibers can impart high tensile strength to the filter medium in combination with improved burst strength, whereas hardwood derived fibers can adjust porosity and thereby filtration efficiency. The softwood may be selected from pine (for example, longleaf pine, shortleaf pine, loblolly pine, slash pine, Southern pine), black spruce, white spruce Jack pine, balsam fir, Douglas fir, western hemlock, redwood, red cedar, northern softwood, southern softwood, hemlock, spruce (for example, black spruce). The softwood fibers may be from a Northern Bleached Softwood kraft (NBSK) pulp. The hardwood may be selected from aspen, birch, beech, oak, maple, eucalyptus and gum.

The relative proportions of softwood and hardwood fibers, respectively, can be selected so that the proportion (based on weight) of the softwood fibers is higher than the proportion of the hardwood fibers in the first portion, the second portion and/or the fibrous layer as a whole. The relative wt:wt proportions of softwood and hardwood fibers, in the first portion, the second portion and/or the fibrous layer as a whole may be 85:15 to 60:40, preferably 80:20 to 65:35.

In an embodiment, the first portion comprises hardwood cellulose fibers and softwood cellulose fibers. Preferably, the relative wt: wt proportions of softwood and hardwood fibers, in the first portion is 85:15 to 60:40, preferably 80:20 to 65:35.

In an embodiment, the second portion comprises synthetic fibers and cellulosic fibers, and preferably the weight:weight ratio of synthetic fibers to cellulosic fibers is 80:20 to 20:80, optionally 30:70 to 70:30, optionally 60:40 to 40:60, optionally wherein the cellulosic fibers in the second portion comprise at least 80 wt % softwood fibers, optionally at least 90 wt % softwood fibers, optionally at least 95 wt % softwood fibers.

In an embodiment, the first portion comprises hardwood cellulose fibers and softwood cellulose fibers and the relative wt:wt ratio of softwood and hardwood fibers, in the first portion is 85:15 to 60:40, preferably 80:20 to 65:35, and the second portion comprises synthetic fibers and cellulosic fibers in a weight:weight ratio of 80:20 to 20:80, optionally 30:70 to 70:30, optionally 60:40 to 40:60, optionally wherein the cellulosic fibers in the second portion comprise at least 80 wt % softwood fibers, optionally at least 90 wt % softwood fibers, optionally at least 95 wt % softwood fibers.

The first portion may contain 10 wt % or less synthetic fibers, optionally 5 wt % or less, optionally 2 wt % or less synthetic fibers, optionally 1 wt % or less synthetic fibers, optionally lacking any synthetic fibers, based on the total amount of fibers in the first portion.

As indicated above, the at least two different types of cellulosic fibers can also differ with respect to other properties, such as titer, average length and/or average fiber diameter. The at least two different types of cellulosic fibers may be different types of fiber, e.g. comprise hardwood and softwood fibers, and may also differ with respect to other properties, such as titer, average length and/or average fiber diameter. Typical average fiber lengths for example are between 0.5 mm and 5 mm, such as from 1 mm to 4 mm. If the different types of fibers are distinguished by their average fiber length, it is preferred that the difference in average fiber length is at least 0.8 mm, preferably at least 1.0 mm, and in embodiments up to 1.5 mm. Optionally, the cellulosic fibers comprise hardwood and softwood fibers, and the hardwood and softwood fibers have different average fiber lengths, optionally wherein the difference in the average fiber lengths is at least 0.8 mm, preferably at least 1.0 mm, and in embodiments up to 1.5 mm.

A suitable example of a combination of cellulosic fibers with different average fiber lengths are a first type of fibers, which may be hardwood fibers, with an average length of for example from 1 to 1.5 mm and a second type of fibers, which may be softwood fibers, with an average length of from 2 to 4 mm, for example 2.5 to 3.5 mm. By suitably combining types of fibers with different average fiber lengths it is possible to adjust and balance the desired target properties, in particular air permeability.

As regards the relative proportion of the different types of fibers, in the first portion, and/or in the fibrous layer as a whole, in relation with the fiber length, it is preferred if the longer fibers, which may be softwood fibers, represent the majority of the fibers present (based on weight) and preferably, the wt:wt ratio in the first portion and/or in the fibrous layer as a whole of longer fibers (which may be softwood fibers):shorter fibers (which may be hardwood fibers) is 85:15 to 60:40, preferably 80:20 to 65:35.

The fiber diameter of cellulose fibers can vary from 10 to 50 μm. they at least two types of cellulose fibers can have different fiber diameters, e.g. average fiber diameters, so that for example one type of cellulose fibers has a diameter, e.g. average diameter, of 30 μm and the other has a diameter, e.g. average diameter, of 20 μm. Preferably, the softwood fibers have a diameter, e.g. average diameter, of 30 μm and the hardwood fibers have a diameter, e.g. average diameter, of 15 μm.

The weight ratio of the fibers in the first portion to the fibers in the second portion is n:1, wherein n is >1, optionally wherein n is 2 to 10, optionally 3 to 5, optionally 3.5 to 4.5 optionally about 4. If the first and second portions are formed by wet laying as described herein, the weight ratio of the fibers in the first and second portions may represent the weight ratio of fibers in, respectively, a first slurry and a second slurry, that are used to form first and second portions in the fibrous layer (i.e. the slurry laid down to form the first and second portions).

The composition of the cellulosic fibers in the first and second portions may be the same or may be different. If the composition is the same, the weight proportions of the different types of cellulosic fibers may be as described above. If the composition of the cellulosic fibers is different in the first and second phase, the difference may be in the relative proportion of the different types of cellulosic fibers. In such a case it is preferred if the weight proportion of softwood derived fibers and/or cellulosic fibers with higher average length is higher in the second portion, compared to the respective proportion in the first portion. For example, in an embodiment, the cellulosic fibers in the fibres (as a whole) in the second portion may comprises at least 80 wt % softwood fibers, optionally 90 wt % softwood fibers, optionally 95 wt % softwood fibers.

It is preferred, if the first phase comprises at least three different types of cellulosic fibers, preferably one hardwood cellulosic fibers and two different types of softwood derived cellulosic fibers, then the second phase then preferably comprises, in addition to the synthetic fibers, at most two different types of cellulosic fibers and even more preferably just one type of cellulosic fibers, preferably softwood cellulosic fibers. It is in particular preferred if in the embodiment described herein the second phase comprises cellulosic fibers with average fiber length in between 2 and 3.5 mm, preferably 2.4 to 3.2 mm.

### Fibrous Layer

The fibrous layer has a first portion and a second portion, and the first portion and second portions are disposed next to each other along a thickness direction of the layer. The first portion and second portion may be lamellar, i.e. having first and second dimensions that are both larger than a third dimension (i.e. a thickness direction), and typically overlie one another and occupy the same area of the fibrous layer. The thickness direction is from one face of the layer to the other face of the layer, and is typically the shortest distance from opposing faces of the layer. The fibers from the first portion are intermeshed with the fibers from the second portion—this may be from forming first and second portion together, e.g. by wet laying both first and second portion together, as described herein, to allow intermeshing of the fibers. Accordingly, at the point where the first and second portions meet in the layer, fibers from the first portion intermesh with the second portion, binding first and second portions together. This allows a continuum of the intermeshed fibrous structure through the thickness of the layer and therefore a continuum of voids through the thickness of the layer, and avoids an abrupt interface as would be seen when two separately-formed fibrous layers are contacted together.

The fibrous layer may have a basis weight of from 50 g/m² to 250 g/m², optionally 75 g/m² to 200 g/m², optionally 90 g/m² to 200 g/m², optionally 100 g/m² to 150 g/m², optionally 80 g/m² to 130 g/m². Basis weight may be measured according to DIN EN ISO 536:2019-11. The fibrous layer may have a thickness of from 0.3 mm to 1 mm, preferably from 0.3 mm to 0.6 mm. The thickness may be measured according to DIN EN ISO 534:2012-02 but using a test pressure of 0.1 bar.

The mean pore size of the fibrous layer can be adjusted by appropriately selecting the fibers in the fibrous layer. As the skilled person will appreciate, the cellulosic fibers, in particular depending on the average fiber length, can be employed to adjust the mean pore size of the filter medium obtained. The fibrous layer may have a mean pore size of from 5 to 40 μm, optionally from 10 to 40 μm, optionally from 15 to 40 μm, optionally from 20 to 40 μm optionally from 25 to 40 μm, optionally from 20 to 35 μm, optionally from 25 to 35 μm optionally from 30 to 35 μm, 8 to 35 μm as determined according to DIN ISO 4003:1910-10 and/or an air permeability of at least 165 l/m²s as determined according to DIN EN ISO 9237 1995-12 at 200 Pa pressure difference.

The mean pore size of the fibrous layer may be measured according to DIN ISO 4003:1990, which may be as described in more detail in the Examples below.

The maximum pore size of the fibrous layer may be from 35 μm to 50 μm, preferably from 35 μm to 48 μm. The maximum pore size may be measured according to DIN ISO 4003:1990, which may be as described in more detail in the Examples below.

The air permeability of the fibrous layer, before any application of a flame retardant, may be from 50 to 280 l/m²·sec, optionally from 70 to 280 l/m²·sec, optionally from 50 to 200 l/m²·sec optionally from 80 to 200 l/m²·sec, optionally from 70 to 150 l/m²·sec. The air permeability of the fibrous layer, before any application of a flame retardant, may be at least 150 l/m²sec, preferably at least 160 l/m² sec, preferably from 150 l/m²·sec to 200 l/m²·sec, preferably from 160 l/m² sec to 200 l/m²·sec.

The burst strength of the fibrous layer, after application of a flame retardant, may be from 100 kPa to 600 kPa and preferably from 150 kPa to 300 kPa. The burst strength may be measured according to according to DIN EN ISO 2758-2014-12.

The Dust Holding Capacity (DHC) may be at least 100 g/m², preferably at least 110 g/m², preferably at least 120 g/m². preferably from 100 g/m² to 150 g/m², preferably from 110 g/m² to 150 g/m², preferably from 120 g/m² to 140 g/m², preferably from 120 g/m² to 130 g/m². The filter efficiency may be at least 98%, preferably at least 99%, preferably at least 99.5%, preferably at least 99.8%, preferably at least 99.9%. The Dust Holding Capacity and Filter Efficiency may be measured based on flat sample measurement according to ISO 5011:2014, under the following conditions: Test dust ISO 12103-A2 (ISO Fine), Mass concentration: 1 g/M³, Incoming flow velocity 4.2 cm/s; and Filter area: 100 cm².

Tensile Strength (CD) according to DIN EN ISO 1924-2 2009-05 (deviation: test sample length 100 mm (trigger speed 11 mm/min); Elongation at Break (CD and MD) according to DIN EN ISO 1924-05 2009_00.

### Method of Forming Fibrous Layer

Herein is also disclosed a method of making a filter medium, the method comprising forming a fibrous layer on a substrate, wherein the fibrous layer has a first portion and a second portion, such that the first portion and second portion are disposed next to each other along a thickness direction of the layer, and the fibers from the first portion being intermeshed with the fibers from the second portion, and removing the fibrous layer from the substrate.

The first and second portion formed may be as described herein, e.g, wherein the weight ratio of the fibers in the first portion to the fibers in the second portion is n:1, wherein n is >1, and wherein the fibrous layer comprises synthetic fibers, and two different types of cellulosic fiber, the synthetic fibers constitute less than 20 wt % of the fibers in the fibrous layer, and the second portion comprises more synthetic fibers, in terms of mass per unit area, than the first portion.

The fibrous layer may be made using any suitable technique that allows intermeshing of fibers, including, but not limited to, wet laying, air laying and foam forming or laying of fibers. Wet laying is preferred, since it typically results in a thinner fibrous layer than, for example, air laying. Foam laying of fibers is described in the prior art, e.g. in Foam forming of fiber products: a review, Journal of Dispersion Science and Technology, Volume 43, 2022—Issue 10. Air laying of fibers is known in the art, and may involve the use of chemically modified cellulose fibers, e.g. cellulose fibers, which may be hardwood or softwood cellulose fibers as described herein, may be chemically modified cellulose fibers, e.g. chemically treated with a compound comprising a polyvalent cation; suitable polyvalent cations include, but are not limited to, beryllium, magnesium, calcium, strontium, barium, titanium, zirconium, vanadium, chromium, molybdenum, tungsten, manganese, iron, cobalt, nickel, copper, zinc, aluminum and tin, and the compound may be an inorganic salts that may be selected from chlorides, nitrates, sulfates, borates, bromides, iodides, fluorides, nitrides, perchlorates, phosphates, hydroxides, sulfides, carbonates, bicarbonates, oxides, alkoxides phenoxides, phosphites, and hypophosphites. For the purpose of the description herein, such chemically modified cellulosic fibers are classed under cellulosic fibers, and are not included in the classification of synthetic fibers.

In a preferred embodiment, the fibrous layer is wet laid from two different slurries—a first slurry containing fibers that form the first portion and a second slurry containing fibers that form the second portion, the method involving either:
1. wet laying the first portion on the substrate by disposing the first slurry on the substrate, and, while the first portion is still wet, wet laying the second portion on the first portion, to allow intermeshing of the fibers in the first portion with the second portion, and then removing liquid from the first and second portions to form the fibrous layer, or
2. wet laying the second portion on the substrate by disposing the second slurry on the substrate, and while the second portion is still wet, wet laying the first portion on the second portion, to allow intermeshing of the fibers in the first portion with the second portion, and then removing liquid from the first and second portions to form the fibrous layer. Preferably, the method involves a. above. The first and second slurries may be aqueous slurries, i.e. water having fibers dispersed therein.

The first and second slurries may be wet laid using a paper making machine, such as a fourdrinier or a rotoformer. The paper making machine preferably has a dual channel headbox, i.e. allowing two different slurries to be laid on top of one another.

The substrate may be a porous substrate, such as a wire mesh or porous screen, that allows liquid from the slurries to flow through, but not the fibers from the slurries to flow through. The liquid may be removed by vacuum, e.g. by reducing the pressure below the porous substrate, to effect a flow of liquid through the substrate.

The fibrous layer may be dried and further processed, e.g. by calendaring, to form a dry fibrous layer for use in filtration.

The first slurry and second slurries as applied to the substrate may, respectively, contain the various types and proportions of fibers in the same quantities as described above for the first and second portions of the fibrous layer. The concentrations of the different types of fibers within the first and second slurries and the relative volumes of first and second slurries applied to the substrate can be adjusted to reflect the desired relative amounts of fibers within the first and second portions. For example, the weight ratio of the fibers in the first portion to the fibers in the second portion is n:1, wherein n is >1. Accordingly, to achieve this with first and second slurries with the same total concentration of fibers as one another, a greater volume of the first slurry is laid down on a substrate (to form the first portion) in a wet laying technique, than the volume of the second slurry laid down on the first portion; similarly, where the first and second slurries have same total concentration of fibers then the relative volumes of first and second slurries laid down on the substrate (or, in the case of the second slurry, on the first portion formed by the first slurry), i.e. volume of first slurry:volume of second slurry, may be n:1, e.g, wherein n is 2 to 10, optionally 3 to 5, optionally 3.5 to 4.5 optionally about 4. If the total concentration of fibers in first and second slurries is different, then the volume of the slurry laid down on the substrate will be adjusted accordingly, to ensure that the weight ratio of the fibers in the first portion to the fibers in the second portion is n:1, wherein n is >1.

Similarly, the concentrations of synthetic fibers, first and second cellulosic fibers in the first and second slurries, and the volumes of the first and second slurries applied, respectively, to the substrate to form first and second portions, are adjusted to ensure that the synthetic fibers constitute less than 20 wt % of the fibers in the fibrous layer (as a whole), and that the second portion comprises more synthetic fibers, in terms of mass per unit area, than the first portion.

The synthetic fibers may constitute less than 20 wt % of the fibers in the first and second slurries as a whole. The synthetic fibers may constitute 3 to 15 wt.-%, more preferably from 5 to 10 wt.-%, more preferably 8 to 16 wt % of the fibers in the first and second slurries as a whole. Preferably, the second slurry comprises synthetic fibers and cellulosic fibers in a weight:weight ratio of 80:20 to 20:80, optionally 30:70 to 70:30, optionally 60:40 to 40:60, optionally 58:42 to 42:58, optionally from 45:55 to 55:45, optionally about 50:50. Preferably, at least 80 wt % of the synthetic fibers in the combined amount of synthetic fibers in the first and second slurries are present in the second slurry, optionally at least 70 wt %, optionally at least 80 wt %, optionally at least 90 wt %.

The first and second slurries may, collectively, comprise two different types of cellulosic fiber. The first slurry preferably comprises two different types of cellulosic fiber. The at least two different types of cellulosic fibers may differ with respect to at least one selected from the fiber titer, fiber origin (hardwood/softwood), average fiber diameter, and average fiber length, as described above.

Preferably, the two different types of cellulosic fiber within the first and second slurries are hardwood fibers and softwood fibers. Preferably, the first slurry comprises two different types of cellulosic fiber: hardwood fibers and softwood fibers. The relative proportions (or concentrations) of softwood and hardwood fibers in the first slurry can be selected so that the concentration of the softwood fibers is higher than the concentration of the hardwood fibers in the first slurry. In the first slurry, the relative concentrations of softwood and hardwood fibers (concentration of softwood fibers in the first slurry: concentration of hardwood fibers in the first slurry) may be 85:15 to 60:40, preferably 80:20 to 65:35.

In an embodiment, the second slurry comprises synthetic fibers and cellulosic fibers and the relative concentrations of synthetic fibers and cellulosic fibers in the second slurry (concentration of synthetic fibers in the second slurry: concentration of cellulosic fibers in the second slurry) is 80:20 to 20:80, optionally 30:70 to 70:30, optionally 60:40 to 40:60, optionally wherein the cellulosic fibers in a given unit volume of second slurry comprise at least 80 wt % softwood fibers.

In an embodiment, in the first slurry, the relative concentrations of softwood and hardwood fibers (concentration of softwood fibers in the first slurry:concentration of hardwood fibers in the first slurry) may be 85:15 to 60:40, preferably 80:20 to 65:35 and the second slurry comprises synthetic fibers and cellulosic fibers and the relative concentrations of synthetic fibers and cellulosic fibers in the second slurry (concentration of synthetic fibers in the second slurry:concentration of cellulosic fibers in the second slurry) is 80:20 to 20:80, optionally 30:70 to 70:30, optionally 60:40 to 40:60, optionally wherein the cellulosic fibers in a given unit volume of second slurry comprise at least 80 wt % softwood fibers.

In the first slurry, in a given volume, the synthetic fibers may constitute 10 wt % or less of the total amount of fibers, optionally 5 wt % or less of the total amount of fibers, optionally 2 wt % or less of the total amount of fibers, optionally 1 wt % or less of the total amount of fibers, optionally the first slurry lacks any synthetic fibers.

As regards the relative concentrations of the different types of fibers in the first slurry, in relation to the fiber length, it is preferred that the longer fibers, which may be softwood fibers, represent the majority of the fibers present (based on weight), with the remaining fibers being shorter fibers, which may be hardwood fibers, with suitable relative concentrations of longer fibers:shorter fibers (concentration longer fibers:concentration shorter fibers) being from 85:15 to 60:40, preferably 80:20 to 65:35.

### Subsequent Treatment/Processing of Filter Medium

After forming the fibrous layer, it may be subjected to subsequent treatments, such as processes to impart a surface structure or impregnation steps. One example thereof is an impregnation with binder systems, which are employed to improve mechanical as well as thermal properties as well as other target properties.

The binder may be a polymeric binder, and may be impregnated into the fibrous layer after its formation. The polymeric binder may be selected from a polyvinyl acetate, an epoxy, a polyester, a polyvinyl alcohol, an acrylic such as a styrene acrylic, and a phenolic resin. The binder may constitute from 1% to 35% of the basis weight of the fibrous layer. The fibrous layer may have been impregnated asymmetrically with two different types of binder, i.e. the fibrous layer has two sides, a first and second side, with the first side having been impregnated with a first binder and the second side having been impregnated with a second binder, and first and second binders are different to one another. In an embodiment, the first side is impregnated with a pre-crosslinked binder system, the pre-crosslinked binder system being cured to 30% to 80% of its theoretical final curing, and the other, second side is impregnated with a crosslinkable, but not yet or largely not crosslinked binder system (UB), which is cured to a maximum of 30% of its theoretical final curing. The pre-crosslinked binder system may be thermally pre-crosslinked, wherein it is crosslinked to 30 to 80% of the theoretical final crosslinking thereof after a heat treatment step at below 120° C. The crosslinkable, but not yet crosslinked binder system may be thermally crosslinkable, wherein it is crosslinked to a maximum of 30% of the theoretical final crosslinking thereof after a heat treatment step at below 120° C. Optionally, at least one of the two different binder systems penetrates the filter material by at least half and at most three quarters of the thickness thereof. Optionally, each of the two different binder systems penetrates the filter material by at least half and at most three quarters of the thickness thereof. Optionally, the filter material has an acetone extract of from 50 to 100% on the pre-crosslinked side and from 0 to 50% on the non-crosslinked or little crosslinked side. Suitable asymmetric impregnation processes as well as compositions are further described in EP3393617B1 and U.S. Pat. No. 11,198,079 B2, which are both herewith incorporated by reference.

Such asymmetric impregnation may be employed to impregnate the filter medium in also with other components, such as flame retardants, colouring agents (which may be employed for the visual inspection of filter medium materials during further processing as well as during use) and other commonly employed additives added to the layer or layers described herein employed as filter materials. Flame or fire retardants include, but are not limited to, phosphor-organic compounds. Any type of impregnation can be used to impregnate the filter medium.

### Filter Element

The present description, in a third aspect, further provides a filter element comprising the filter medium according to the first aspect or producible according to the second aspect. The filter element may comprise a single filter medium or a plurality of the filter media as described herein. The filter element may comprise a housing that contains a filter medium or a plurality of the filter media as described herein. The filter element may be selected from flat-panel filter element, cartridge filter element, and cylindrical or conical filtration element. The filter element may be selected from a radial filter element, a panel filter element, and a channel flow element. The filter element may be suitable for use as a dust collector, for example in commercial, industrial or residential HVAC (heating, ventilation and air conditioning) systems.

The present description, in a fourth aspect, further provides a use of the filtration medium of the first aspect or the filter element of the third aspect in filtering a fluid. The filtering may act to remove particulates, e.g. dust, from the fluid. The fluid may be a gas or a liquid. The gas may be air. The liquid may be a fuel or lubricating liquid, e.g. a hydrocarbon fuel or lubricating oil. The fluid may be a gas and the gas may be flowing at a velocity of 20 cm/s or less, optionally 15 cm/s or less, optionally 10 cm/s or less.

The filter medium described herein is particularly effective for dust collection from air flow, particularly where the air flow is low velocity. The filter medium nevertheless may be used in a variety of filter elements, including, but not limited to, gas turbine filter elements, dust collector elements, heavy duty air filter elements, automotive air filter elements, HVAC air filter elements, HEPA filter elements, vacuum bag filter elements, fuel filter elements, and oil filter elements.

The filter medium or media in the filter element may be of any suitable shape or configuration. The filter medium or media may, for example, be corrugated or pleated.

Embodiments of the filter medium are further described, without limitation, in the following FIGURE and Examples.

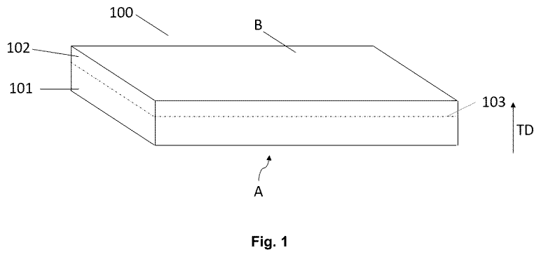

An embodiment of the filtration medium described herein is illustrated schematically in FIG. 1. In this FIGURE is shown a layer 100, which has a first portion 101 and a second portion 102. The first portion and second portion are disposed next to each other along a thickness direction (TD) of the layer 100. First and second portions comprise fibers (not shown) and the fibers of first and second portions intermesh where the first and second portions meet (103)—as such, there is no macroscopic abrupt interface between first and second portions, as there would be had two layers been created separately and adhered to one another. The weight ratio of the fibers in the first portion 101 to the fibers in the second portion 102 is n:1, wherein n is >1, shown schematically by the first portion 101 being thicker than the second portion 102. The first and second portions together form a single layer having opposing surfaces or sides A and B.

### Examples

The following Examples describe the production of various types of filter medium and their efficacy in various tests. The test methods employed to determine various properties of the filter mediums are described in more detail below. The materials and methods used to make the filter media are then described, followed by the results of the tests.

### Test Methods

Pore size: The pore size is measured with reference to DIN ISO 4003:1990. The sample is placed between an air-tight clamp over an orifice equipped with air supply and a connection to a pressure gauge (U-tube with mm indicator). Each sample is tested with the upper side facing upwards. Denatured ethanol (ethanol 100% with 1% MEK (Methyl-Ethyl-Ketone) as denaturant) is poured over the edge of the upper specimen holder (do not spray directly onto the sample/approx. 4 mm depth) to achieve a slight excess of air pressure on the liquid. The air pressure is slowly increased (approx. 5 mm water gauge/sec) until the first air bubble is visible. The necessary air pressure level is to be read from the pressure gauge (in mm water gauge). With the help of the surface tension of the ethanol (23° C.), the diameter of the largest pore (“Maximum Pore”, “maximum pore size”, “maximum pore diameter”) can be calculated.

The air pressure is then increased further, until air is passing through the sample over the entire surface (10 cm²) with an even distribution of bubbles but without foaming to determine the value for “mean pore size”. The air pressure is read off again and the relative pore diameter, i.e. mean pore size is calculated.

The “maximum pore size” and “mean pore size” can be calculated as described above by using the following formula:

$$d = \frac{4 σ \cdot cos α}{p} \cdot 1.$$

$$d = Pore diameter [ μm ]$$

$$p = Air pressure [ mN / {m}^{2} )$$

$$σ = Surface tension of the test liquid ( e . g . ethanol )$$

$$[ Ethanol at 23 °C . σ = 21.330225 mN / m ]$$

$$α = Contact angle at the area where the liquid and the sample meet$$

$$( Conversion : 1 mm Water Gauge = 98.07 mN / {m}^{2} )$$

Thickness: the thickness as described in the present application has been measured according to DIN EN ISO 534:2012-02 but using a test pressure of 0.1 bar.

Basis weight: according to DIN EN ISO 536:2019-11

Burst Strength: according to DIN EN ISO 2758-2014-12

Dust Holding Capacity and Filter Efficiency: the stated efficiency values were measured based on flat sample measurement according to ISO 5011:2014. Test conditions:
Test dust ISO 12103-A2 (ISO Fine)
Mass concentration: 1 g/M³
Incoming flow velocity 4.2 cm/s
Filter area: 100 cm²
   The total efficiency and dust holding capacity are measured when a final pressure of 500 Pa is reached.

Air Permeability: according to DIN EN ISO 9237 1995-12 at 200 Pa pressure difference.

### Materials and Methods Used for Making the Filter Media

Using wet laying techniques, single layer filter media were prepared, comprising either a single portion or a dual portion structure. In the case of dual portion structures, the two portions are designated BL and OL; BL corresponds to the first portion as described herein and OL corresponds to the second portion as described herein. All indications in % in relation to the proportion of components and portions relate to the respective weight.

In the following, ‘NBSK’ refers to Northern bleached softwood kraft; ‘synthetic fibers’ refers to polyester (PET) short cut staple fibers having a linear density of 0.23 and a cut length of 3 mm.

The following filter media were prepared

CE1: Single portion layer comprising 100% cellulosic fibers (25% Eucalyptus; 78% NBSK fibers)

CE2: Dual portion single layer, 100% cellulosic fibers; OL/second portion (constitutes 15% of fibers of the final single layer) comprising 100% NBSK; BL/first portion (constitutes 85% of the fibers of the single layer) comprising 22% eucalyptus and 78% NBSK fibers

CE3: Dual portion single layer, 100% cellulosic fibers; OL/second portion (constitutes 20% of the fibers of the final single layer) comprising 100% NBSK; BL/first portion (constitutes 80% of the fibers of the final single layer) comprising 23% eucalyptus and 78% NBSK.

CE4: Single portion saturated single layer comprising 90% cellulosic fibers (7.6% eucalyptus; 72.4% NBSK fibers); 10% synthetic fibers (0.2 dtex/3 mm).

EP1: Dual portion single layer; OL/second portion (constitutes 20% of the fibers of the final single layer) comprising 50% NBSK and 50% synthetic fiber (0.2 dtex/3 mm); BL/first portion (constitutes 80% of the fibers of the final single layer) comprising 22% eucalyptus and 78% NBSK.

EP2: Dual portion single layer; OL/second portion (constitutes 20% of the fibers of the final single layer) comprising 50% NBSK and 50% synthetic fiber (glass fiber); BL/first portion (constitutes 80% of the fibers of the final single layer) comprising 22% eucalyptus and 78% NBSK.

EP3: Dual portion saturated single layer; OL/second portion (constitutes 20% of the fibers of the final single layer) comprising 50% NBSK and 50% synthetic fiber; BL/first portion (constitutes 80% of the fibers of the final single layer) comprising 22% eucalyptus and 78% NBSK.

These filtration media are summarised in Table 1 below, which indicates whether each filtration medium contained a single or dual portion structure, and gives indications of the weight proportion of each portion of the whole layer, and the weight proportions of different types of fibers in each portion.

TABLE 1

| | | Proportion | Compositions |
|---|---|---|---|
| | | weight % (of | (fibers present |
| | | fibers in the | and wt % in |
| Example | Design | whole layer) | each portion) |
| Comparative | Single | N/A | 25% Eucalyptus; |
| example 1 (CE1) | Portion | | 78% NBSK fibers |
| Comparative | Dual | OL: 15% | OL: |
| example 2(CE2) | Portion | BL: 85% | 100% NBSK |
| | | | BL: |
| | | | 22% Eucalyptus; |
| | | | 78% NBSK fibers |
| Comparative | Dual | OL: 20% | OL: |
| example 3 (CE3) | Portion | BL: 80% | 100% NBSK |
| | | | BL: |
| | | | 23% Eucalyptus; |
| | | | 77% NBSK fibers |
| Comparative | Single | N/A | 10% Synthetic fibers |
| example 4 (CE4) | Portion | | 7.6% Eucalypus; |
| | | | 72.4% NBSK fibers |
| Experimental | Dual | OL: 20% | OL: |
| example 1 (EP1) | Portion | BL: 80% | 50% NBSK |
| | | | 50% synthetic fiber). |
| | | | BL: |
| | | | 22% Eucalyptus; |
| | | | 78% NBSK fibers |
| Experimental | Dual | OL: 20% | OL: |
| example2 (EP2) | Portion | BL: 80% | 50% NBSK |
| | | | 50% Glass fiber |
| | | | BL: |
| | | | 22% Eucalyptus; |
| | | | 78% NBSK fibers |
| Experimental | Dual | OL: 20% | OL: |
| example (EP3) | Portion | BL: 80% | 50% NBSK |
| | (saturated) | | 50% synthetic fiber |
| | | | BL: |
| | | | 22% Eucalyptus; |
| | | | 78% NBSK fibers |

The term saturated refers to a filter medium having been impregnated with a binder composition according to the teaching of U.S. Pat. No. 11,198,079 B2

### Results

The properties of the media were determined in the tests mentioned above and the results are given below.

TABLE 2

| Av. Value | CE1 | CE2 | CE3 | UNIT |
|---|---|---|---|---|
| grammage | 100.1 | 99.5 | 98.9 | g/m² |
| thickness | 0.44 | 0.48 | 0.46 | mm |
| air permeability | 128.6 | 143 | 162.3 | l/m²s |
| max. pore | 46 | 46 | 50 | μm |
| mean pore size | 36 | 37 | 39 | μm |
| bursting strength | 54.9 | 55.3 | 49.5 | kPa |

Table 2 summarizes relevant properties of examples CE1 to CE3. CE3 has the highest air permeability.

TABLE 3

| Av. Value | EP1 | EP2 | CE3 | UNIT |
|---|---|---|---|---|
| grammage | 98.9 | 97.7 | 98.9 | g/m² |
| thickness | 0.51 | 0.48 | 0.46 | mm |
| air permeability | 171 | 167.7 | 162.3 | l/m²s |
| max. pore size | 41 | 43 | 50 | μm |
| mean pore size | 33 | 30 | 39 | μm |
| bursting strength | 33.6 | 37.8 | 49.5 | kPa |

Table 3 summarizes relevant properties of examples EP1 and EP2, shown in comparison to CE3. It clearly can be derived therefrom that the surprisingly do show the improved balance of properties, in particular a vastly increased air permeability, without sacrificing other properties overly, such as bursting strength. In addition, the max. pore size is reduced, which will lead to higher filtration efficiency.

The examples and the comparative examples were tested with respect to filtration properties. The results are displayed in the following table 4, for each tested material two runs with two samples were made (i.e. CE1-1 refers to the test made with a first sample of the material CE1, while CE1-2 refers to the second test made with a second sample of the material).

TABLE 4

| | air | | | dust |
|---|---|---|---|---|
| | permeability | speed | efficiency | absorption |
| material | [l/m²*s] | [cm/s] | [%] | [g/m²] |
| CE1-1 | 123 | 4.2 | 99.99 | 100 |
| CE1-2 | 125 | 4.2 | 99.88 | 96 |
| CE2-1 | 139 | 4.2 | 99.98 | 107 |
| CE2-2 | 139 | 4.2 | 99.97 | 105 |
| CE3-1 | 160 | 4.2 | 99.92 | 114 |
| CE3-2 | 170 | 4.2 | 99.97 | 111 |
| EP1-1 | 171 | 4.2 | 99.96 | 131 |
| EP1-2 | 171 | 4.2 | 99.95 | 126 |
| EP2-1 | 167 | 4.2 | 99.99 | 128 |
| EP2-2 | 168 | 4.2 | 99.95 | 127 |

Again it can be clearly seen that the examples display highly satisfactory filtration results with high air permeabilities, as compared to the comparative examples. It was also found that while the starting differential pressure (not shown) was lower for the present examples, the overall pressure increase was comparable to the pressure increase for the comparative materials, so that overall the examples display the desired balance of properties.

The filtration media of CE4 were additionally tested in comparison to filtration media of example EP3 which had been subjected to further treatments as indicated below. EP3-A is a filter medium according to example EP3 saturated with a flame retardant. EP3-B on the other hand has been subjected to an asymmetric saturation with a flame retardant (as disclosed in U.S. Pat. No. 11,198,079 B2, which is incorporated herewith) and a subsequent corrugation treatment on the flame retardant saturated side in order to impart a corrugated structure to the filter medium. Relevant properties of these filter media materials are summarized in table 5.

TABLE 5

| Av. Value | EP3-A | EP3-B | CE3 | UNIT |
|---|---|---|---|---|
| grammage | 123.0 | 121.6 | 98.9 | g/m² |
| thickness | 0.43 (0.1 | 0.37 (0.65 | 0.46 (0.1 | mm |
| | bar) | bar) | bar) | |
| air permeability | 99.7 | 111.5 | 162.3 | 1/m²s |
| max. pore size | 41 | 42 | 50 | μm |
| mean pore size | 34 | 34 | 39 | μm |
| bursting | 279 | 180 | 49.5 | kPa |
| strength | | | | |
| Flame | 94.7 | 109.5 | | mm |
| retardancy | | | | |

These results do show that bursting strength can be vastly improved for examples, allowing desired adjustments in target properties. Likewise, it is possible to impart flame retardancy. That these modifications do not sacrifice overly the desired filtration properties has been confirmed by running the respective tests, which are summarized in table 6 below.

TABLE 6

| | air | | | dust |
|---|---|---|---|---|
| | permeability | speed | efficiency | absorption |
| material | [l/m²*s] | [cm/s] | [%] | [g/m²] |
| CE4-1 | 182 | 4.2 | 99.96 | 93 |
| CE4-2 | 183 | 4.2 | 99.92 | 90 |
| EP3-A-1 | 106 | 4.2 | 99.93 | 106 |
| EP3-A-2 | 102 | 4.2 | 99.96 | 103 |
| EP3-B-1 | 113 | 4.2 | 99.99 | 125 |
| EP3-B-2 | 111 | 4.2 | 99.97 | 124 |

The results show that examples can be further modified by treatments such as flame retardant impregnation and/or corrugation, without sacrificing too much of the target filtration properties. At the same time, the differential pressure start values can be increased (not shown), even though air permeability is reduced in comparison to other materials. Nevertheless, the filtration properties still are higher than provided by the comparative examples.

While the devices, systems and methods have been described in detail herein in accordance with certain preferred embodiments thereof, many modifications and changes therein may be effected by those skilled in the art. Accordingly, the foregoing description should not be construed to be limited thereby but should be construed to include such aforementioned obvious variations and be limited only by the spirit and scope of the following claims.

What is claimed is:

1. A filter medium comprising:
a fibrous layer having thickness direction, a first portion and a second portion, the second portion being disposed adjacent the first portion along the thickness direction;
wherein the fibers from the first portion are intermeshed with the fibers from the second portion; and
wherein a weight ratio of the fibers in the first portion to the fibers in the second portion is greater than 1:1.

2. The filter medium of claim 1, wherein the fibrous layer comprises synthetic fibers and cellulosic fibers, wherein the synthetic fibers are present between about 1 wt % to about 20 wt % of a total weight of the fibrous layer.

3. The filter medium of claim 2, wherein the second portion comprises a greater mass per unit area of synthetic fibers than the first portion.

4. The filter medium of claim 2, wherein the synthetic fibers have a linear density of 2 dtex or less.

5. The filter medium of claim 2, wherein the synthetic fibers have a linear density of from 0.01 dtex to 1 dtex, optionally from 0.04 to 0.6 dtex, optionally from 0.05-0.5 dtex, optionally from 0.1 to 0.3 dtex.

6. A filter medium of claim 2, wherein the synthetic fibers have a fiber diameter of from 0.1 μm to 20 μm.

7. The filter medium of claim 2, wherein the synthetic fibers are selected from a group consisting of polymeric fibers, inorganic fibers and combinations thereof.

8. The filter medium of claim 7 wherein the polymeric fibers comprise a material selected from the group consisting of a polyester, a polycarbonate, a polyamides, polyaramid, polyimide, a polyolefin, a polyether ether ketone, an acrylic, a polyvinyl alcohol, a polyacrylonitrile, a polyvinylidene fluoride (PVDF), a silicone, a polyether sulfone and combinations thereof.

9. The filter medium of claim 7, wherein the inorganic fibers comprise a material selected from the group consisting of glass, carbon, ceramic, silica and combinations thereof.

10. The filter medium of claim 1, wherein the first portion comprises hardwood cellulose fibers and softwood cellulose fibers.

11. The filter medium of claim 2, wherein the second portion comprises synthetic fibers and cellulosic fibers in a weight:weight ratio of 80:20 to 20:80.

12. The filter medium of claim 1, wherein the weight ratio of the fibers in the first portion to the fibers in the second portion is about 2:1 to about 10:1.

13. The filter medium of claim 1, wherein the fibrous layer has a mean pore size of from 8 to 35 μm as determined according to DIN ISO 4003:1910-10 and an air permeability of at least 165 l/m²s as determined according to DIN EN ISO 9237 1995-12 at 200 Pa pressure difference.

14. The filter medium of claim 1 wherein the fibrous layer has a basis weight of from 80 to 140 g/m² determined according to DIN 546:2019-11.

15. A filter element comprising the filter medium of claim 1.

16. A method of making a filter medium, the method comprising
forming a fibrous layer on a substrate, wherein the fibrous layer has a first portion and a second portion, such that the first portion and second portion are disposed next to each other along a thickness direction of the layer, and the fibers from the first portion are intermeshed with the fibers from the second portion, wherein a weight ratio of the fibers in the first portion to the fibers in the second portion is greater than 1:1; and
removing the fibrous layer from the substrate.

17. The method of claim 16 wherein the fibrous layer is wet laid from two different slurries—a first slurry containing fibers that form the first portion and a second slurry containing fibers that form the second portion.

18. The method of claim 17, further comprising wet laying the first portion on the substrate by disposing the first slurry on the substrate, and, while the first portion is still wet, wet laying the second portion on the first portion, to allow intermeshing of the fibers in the first portion with the second portion, and then removing liquid from the first and second portions to form the fibrous layer.

19. The method of claim 17, further comprising wet laying the second portion on the substrate by disposing the second slurry on the substrate, and while the second portion is still wet, wet laying the first portion on the second portion, to allow intermeshing of the fibers in the first portion with the second portion, and then removing liquid from the first and second portions to form the fibrous layer.

20. The method of claim 17, wherein the first slurry comprises hardwood cellulose fibers and softwood cellulose fibers, and the second slurry comprises synthetic fibers and cellulosic fibers in a weight:weight ratio of 80:20 to 20:80.
